(19) United States
(12) Patent Application Publication
(10) Pub. No.: US 2003/0164181 A1
(43) Pub. Date: Sep. 4, 2003

(54) Substrate processing apparatus

(75) Inventor: Masami Ohtani, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/375,161

(22) Filed: Feb. 26, 2003

(30) Foreign Application Priority Data
Mar. 1, 2002 (JP) P2002-055749

(51) Int. Cl. B08B 3/00

(52) U.S. Cl. 134/62

(57) ABSTRACT

A cleaning processing part and an ashing processing part are oppositely arranged flush with each other through a transport path where a transport robot is arranged. The cleaning processing part comprises a surface scrubber and a rear scrubber. The ashing processing part performs ashing with plasma. The transport robot transports a substrate to be processed from an indexer successively through the ashing processing part, a reversal part and the cleaning processing part and returns the same to the indexer again. The transport robot immediately transports the substrate completely subjected to ashing toward the cleaning processing part, whereby the time required from ashing to cleaning processing is so reduced that a dead time can be eliminated while cleaning performance can be improved by performing cleaning processing immediately after ashing. Thus, a substrate processing apparatus improving cleaning performance by reducing a dead time up to cleaning processing is provided.

### BACKGROUND OF THE INVENTION

1. Field of the Invention

The present invention relates to a substrate processing apparatus cleaning a semiconductor substrate, a glass substrate for a liquid crystal display, a glass substrate for a photomask or a substrate for an optical disk (hereinafter simply referred to as “substrate”) subjected to prescribed processing such as ashing processing.

2. Description of the Background Art

A product such as a semiconductor device or a liquid crystal display is manufactured by performing a series of processing such as cleaning, resist coating, exposure, development, etching, ion implantation, resist separation, formation of an interlayer dielectric film and thermal processing on a substrate. In the series of processing, resist separation, for example, is generally carried out in a plasma asher reacting gas converted to plasma with resist and vaporizing the resist for removing the same. The plasma asher removes the resist, which is an organic material consisting of carbon, oxygen and hydrogen, by ashing of chemically reacting the resist with oxygen plasma.

In practice, the resist contains slight quantities of non-vaporizable impurities such as heavy metals, and such residual materials adhere to the ashed substrate as particles. In general, therefore, the ashed substrate is cleaned for completely removing the particles.

In general, a plurality of unprocessed substrates stored in a carrier are introduced into the plasma asher, which in turn successively takes out the unprocessed substrates from the carrier and ashes the same. The ashed substrates are temporarily returned to the carrier, which in turn is transported from the plasma asher to a cleaning apparatus while storing the plurality of ashed substrates. The cleaning apparatus successively cleans the substrates taken out from the carrier.

When ashing and cleaning processing are performed in the aforementioned manner, it follows that the carrier temporarily storing the plurality of ashed substrates is thereafter transported from the plasma asher to the cleaning apparatus, leading to a dead time for transporting the carrier between the apparatuses.

When cleaning processing is performed upon a lapse of a certain degree of time after ashing, it follows that particles remaining after ashing strongly adhere to the substrate, to result in reduction of cleaning performance.

### SUMMARY OF THE INVENTION

The present invention is directed to a substrate processing apparatus cleaning a substrate subjected to prescribed processing.

According to the present invention, the substrate processing apparatus comprises a cleaning part, performing cleaning processing on a substrate in a cleaning processing chamber, including a surface cleaning part cleaning the surface of the substrate and a rear cleaning part cleaning the rear surface, a preprocessing part performing prescribed processing in its processing chamber as a processing step immediately preceding the cleaning processing, a reversal part of reversing the upper surface of the substrate and a transport element transporting the substrate between the cleaning processing chamber of the cleaning part, the processing chamber of the preprocessing part and the reversal part, while the cleaning part and the preprocessing part are integrally assembled into the substrate processing apparatus and the transport element takes out a single substrate completely subjected to the prescribed processing from the processing chamber of the preprocessing part, holds the substrate and transports the substrate to the cleaning processing chamber of the cleaning part in the single state.

The preprocessing part and the cleaning part are integrally assembled into the apparatus while the common transport element can transport the substrate from the processing chamber of the preprocessing part to the cleaning processing chamber of the cleaning part in the single state, whereby a dead time up to cleaning processing can be reduced for improving cleaning performance. Further, the cleaning part can clean both of the front and rear surfaces of the substrate.

Preferably, the cleaning part and the preprocessing part are substantially flush with each other.

The time required for transporting the substrate from the preprocessing part to the cleaning part is so reduced that the dead time up to cleaning processing can be further reduced.

More preferably, the cleaning part and the preprocessing part are arranged facing each other across a transport path where the transport element is arranged.

The time required for transporting the substrate from the preprocessing part to the cleaning part is so reduced that the dead time up to cleaning processing can be further reduced.

Accordingly, an object of the present invention is to provide a substrate processing apparatus reducing a dead time up to cleaning processing thereby improving cleaning performance.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing the structure of a substrate processing apparatus according to the present invention;

FIG. 2 is a sectional view of the substrate processing apparatus taken along the line V-V in FIG. 1;

FIG. 3 is a perspective view showing the appearance of a transport robot provided in the substrate processing apparatus shown in FIG. 1;

FIG. 4 is a flow chart showing parts of steps of manufacturing a semiconductor device;

FIGS. 5A and 5B are flow charts showing exemplary procedures of transporting a substrate in the substrate processing apparatus; and

FIG. 6 illustrates correlation between an elapsed time after ashing and adsorptive force of particles to the substrate.

### DESCRIPTION OF THE PREFERRED EMBODIMENTS

An embodiment of the present invention is now described with reference to the drawings.

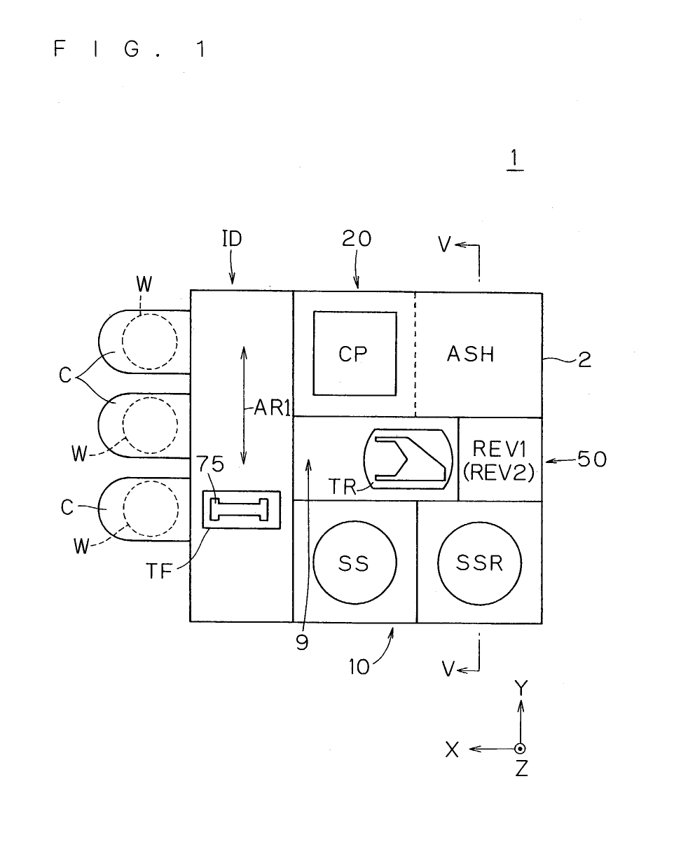

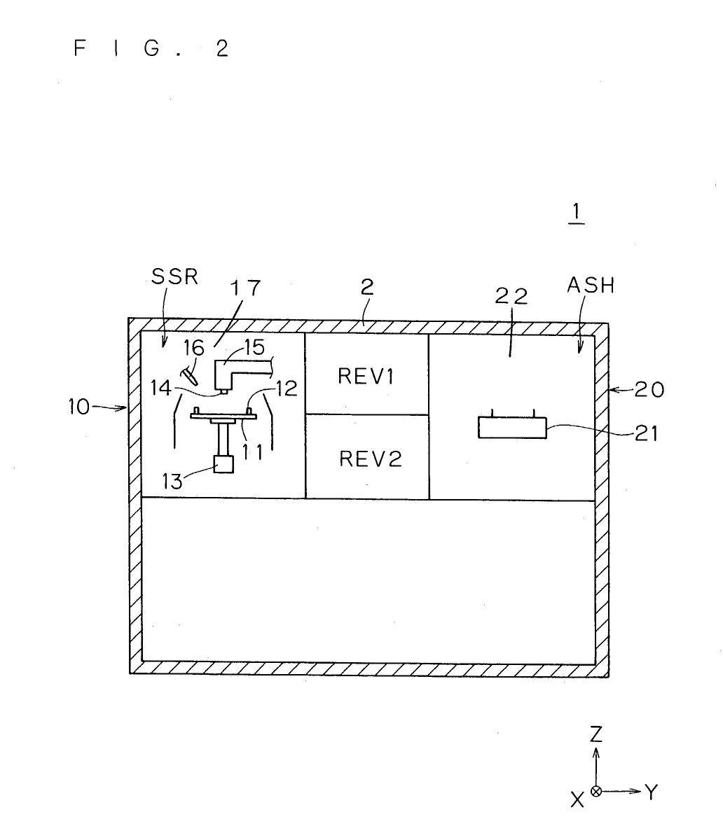

FIG. 1 is a plan view showing the structure of a substrate processing apparatus 1 according to the embodiment of the present invention. FIG. 2 is a sectional view taken along the line V-V in FIG. 1. A Cartesian coordinate system having a Z-axis direction as the vertical direction and an X-Y plane as the horizontal plane is provided to each of FIGS. 1 to 3, in order to clarify the directional relation. The substrate processing apparatus 1 is employed for ashing a substrate W and subsequently cleaning the substrate W. The substrate processing apparatus 1 comprises an indexer ID, a cleaning processing part 10, an ashing processing part 20, a transport robot TR and a reversal part 50.

The indexer ID has carriers C each capable of storing a plurality of substrates W and comprises a transfer robot TF for taking out unprocessed substrates W from the carriers C and delivering the same to a transport robot TR while receiving processed substrates W from the transport robot TR and storing the same in the carriers C. Each carrier C has a number of storage grooves, each of which can horizontally store a single substrate W with the main surface along the horizontal plane. Therefore, each carrier C can horizontally store a plurality of (e.g., 25) substrates W in a state stacked in a plurality of stages at prescribed intervals. While each carrier C is formed by a FOUP (front opening unified pod) storing the substrates W in a closed space in this embodiment, the present invention is not restricted to this but the carrier C may alternatively be formed by an SMIF (standard mechanical interface) pod or an OC (open cassette) exposing the stored substrates W to the outside air.

Each carrier C is provided on its front face (-X side in FIG. 1) with a lid, which is detachable to be capable of introducing/discharging the substrates W. A pod opener (not shown) attaches/detaches the lid to/from the carrier C. The pod opener detaches the lid from the carrier C, thereby defining an opening capable of passing the substrates W therethrough. The indexer ID introduces/discharges the substrates W into/from the carrier C through this opening. In general, an AGV (automatic guided vehicle) or an OHT (overhead hoist transport) automatically places and discharges the carrier C on and from the indexer ID.

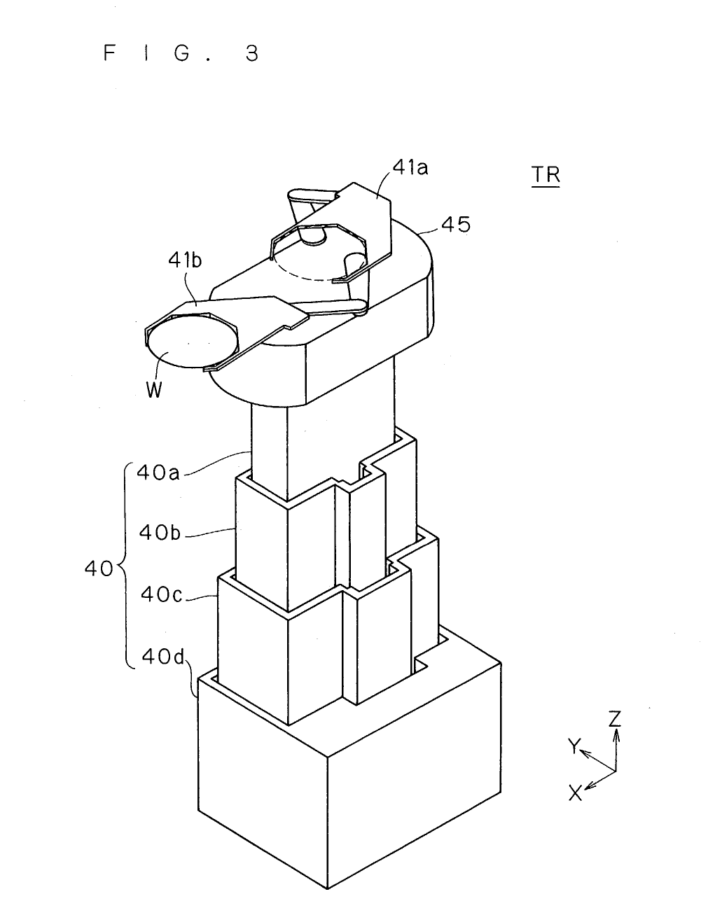

The transfer robot TF is similar in structure to the transport robot TR (FIG. 3) described later. The transfer robot TF is different from the transport robot TR described later in a point that the same comprises not two transport arms 41a and 41b but a single transfer arm 75 having a different shape and a point that the same has a Y-axis direction drive mechanism (not shown) consisting of a ball screw and a guide rail to be horizontally movable along the Y-axis direction as shown by arrow AR1 in FIG. 1, while the former is identical to the latter in the remaining points. Therefore, the transfer robot TF can vertically move the transfer arm 75, horizontally move the same along the Y-axis direction, rotate the same and horizontally reciprocate the same. In other words, the transfer robot TF can three-dimensionally move the transfer arm 75.

According to this structure, the transfer robot TF can take out unprocessed substrates W from each carrier C, transfer the same to the transport robot TR, receive processed substrates W from the transport robot TR and store the same in any carrier C.

The cleaning processing part 10 and the ashing processing part 20 are oppositely arranged through a transport path 9 where the transport robot TR is arranged, and integrally assembled into a housing 2 of the substrate processing apparatus 1. An end of the transport path 9 is in contact with the indexer ID, while the other end thereof is provided with the reversal part 50.

The cleaning processing part 10 comprises a surface scrubber SS and a rear scrubber SSR respectively. The surface scrubber SS rotates each substrate W in a horizontal plane while upwardly directing the surface (device surface) thereof in its cleaning processing chamber, discharges a rinsing solution (deionized water) onto the surface and brings a cleaning brush into contact with the surface or approaches the former to the latter thereby performing surface cleaning processing. The surface scrubber SS is formed by the so-called vacuum chuck vacuum-adsorbing the rear surface (surface opposite to the device surface) of the substrate W.

On the other hand, the rear scrubber SSR rotates the substrate W in a horizontal plane while upwardly directing the rear surface thereof in its cleaning processing chamber 17, discharges a rinsing solution (deionized water) onto the rear surface and brings a cleaning brush into contact with the rear surface or approaches the former to the latter thereby performing rear surface cleaning processing. The rear scrubber SSR, incapable of adsorbing/holding the device surface, is formed by the so-called mechanical chuck grasping the peripheral edge of the substrate W.

FIG. 2 shows a partial structure of the rear scrubber SSR. A plurality of pins 12 are uprightly provided on the upper surface of a rotary base 11. An opening/closing mechanism (not shown) can open/close the pins 12 arranged along the outer periphery of the held substrate W with respect to the substrate W. In other words, the pins 12 are formed to approach/separate to/from the peripheral edge of the substrate W. The plurality of pins 12 come into contact with and press the peripheral edge of the substrate W, thereby horizontally holding the substrate W on the rotary base 11. When the plurality of pins 12 separate from the peripheral edge of the substrate W in an open state, the substrate processing apparatus 1 can take out the substrate W from the rotary base 11 and transfer a new substrate W to the rotary base 11.

A motor 13 rotatably supports the rotary base 11 about a rotation axis along the vertical direction. The motor 13 rotates the rotary base 11 holding the substrate W, thereby rotating the substrate W in the horizontal plane.

The rear scrubber SSR is further provided with a cleaning brush 14 and a deionized water discharge nozzle 16. The deionized water discharge nozzle 16 is communicatively connected to a deionized water supply source (not shown). The cleaning brush 14 is mounted on the forward end of a brush arm 15. A drive mechanism (not shown) can vertically move the brush arm 15 and swing the same in a horizontal plane. In order to clean the rear surface of the substrate W, the substrate processing apparatus 1 rotates the substrate W and swings the brush arm 15 in a state of bringing the cleaning brush 14 into contact with the upper surface (rear surface) of the substrate W or approaching the former to the latter while discharging deionized water from the deionized discharge nozzle 16 as the rinsing solution onto the rear surface of the substrate W thereby removing contaminants such as particles adhering to the rear surface of the substrate W. The surface scrubber SS is similar in structure to the rear scrubber SSR, except that the same employs the vacuum chuck in principle.

The ashing processing part 20 has an ashing part ASH and a cooling part CP built therein. The ashing part ASH comprises a processing chamber 22 storing a heating plate 21 (FIG. 2), a vacuum system evacuating the processing chamber 22, a processing gas supply mechanism supplying processing gas such as oxygen to the processing chamber 22 and a plasma formation mechanism forming plasma by applying a high-frequency field. According to this structure, the ashing part ASH can ash the substrate W placed on the heating plate 21 with the oxygen plasma while evacuating the periphery thereof. As already described, the term “ashing” denotes processing of vaporizing resist, which is an organic material, with oxygen plasma.

The cooling part CP built in the ashing processing part 20 comprises a cooling plate in a processing chamber (not shown), for cooling the substrate W placed on the cooling plate to a prescribed temperature with a Peltier element or through isothermal water circulation. The cooling part CP is employed for cooling the substrate W heated by ashing to a temperature allowing cleaning processing.

As shown in FIG. 2, the cleaning processing part 10 and the ashing processing part 20 are arranged substantially flush with each other, facing each other across the transport path 9 in this embodiment. A space located under the transport path 9, the cleaning processing part 10 and the ashing processing part 20 serves as a cabinet storing solution pipes and electric wires.

The transport robot TR is arranged on the central portion of the transport path 9 sandwiched between the cleaning processing part 10 and the ashing processing part 20.

FIG. 3 is a perspective view showing the appearance of the transport robot TR. The transport robot TR is provided with an arm stage 45 comprising the two transport arms 41a and 41b on a telescopic body 40, which implements a multistage telescopic structure.

The telescopic body 40 is formed by four divided bodies 40a, 40b, 40c and 40d in descending order. The divided body 40a is storable in the divided body 40b, which in turn is storable in the divided body 40c, which in turn is storable in the divided body 40d.

The telescopic body 40 contracts by successively storing the divided bodies 40a to 40d and expands by successively drawing out the divided bodies 40a to 40d. In other words, the divided body 40b stores the divided body 40a, the divided body 40c stores the divided body 40b and the divided body 40d stores the divided body 40c in contraction of the telescopic body 40. In expansion of the telescopic body 40, on the other hand, the divided body 40a is drawn out from the divided body 40b, which in turn is drawn out from the divided body 40c, which in turn is drawn out from the divided body 40d.

A stretchable hoisting mechanism provided in the telescopic body 40 implements expansion/contraction of the telescopic body 40. The stretchable hoisting mechanism can be formed by a mechanism driving a combination of a plurality of sets of belts and rollers with a motor, for example. The transport robot TR can vertically move the transport arms 41a and 41b through this stretchable hoisting mechanism.

The transport robot TR can also horizontally reciprocate and rotate the transport arms 41a and 41b. More specifically, the arm stage 45 provided on the divided body 40a horizontally reciprocates and rotates the transport arms 41a and 41b. In other words, the arm stage 45 bends and stretches respective arm segments of the transport arms 41a and 41b thereby horizontally reciprocating the transport arms 41a and 41b, while the arm stage 45 itself rotates with respect to the telescopic body 40 thereby rotating the transport arms 41a and 41b.

Therefore, the transport robot TR can vertically move the transport arms 41a and 41b, rotate the same and horizontally reciprocate the same. In other words, the transport robot TR can three-dimensionally move the transport arms 41a and 41b for introducing/discharging the substrate W into/from both of the cleaning processing chamber of the cleaning processing part 10 (more specifically, the cleaning processing chamber of the surface scrubber SS or the cleaning processing chamber 17 of the rear scrubber SSR) and the processing chamber of the ashing processing part 20 (more specifically, the processing chamber 22 of the ashing part ASH or the processing chamber of the cooling part CP). The transport arms 41a and 41b holding the substrate W three-dimensionally move to transfer the substrate W between the indexer ID, the cleaning processing part 10, the ashing processing part 20 and the reversal part 50, so that the cleaning processing part 10 and the ashing processing part 20 can clean and ash the substrate W respectively. As already described, the transfer robot TF of the indexer ID is similar in structure to the transport robot TR except the shape and the number of the arm 75 and a point that the same is movable along the Y-axis direction.

The reversal part 50 arranged on the end of the transport path 9 is formed by stacking two reversal units REV1 and REV2 in two stages. Both of the reversal units REV1 and REV2 are formed to be capable of grasping the peripheral edge of the substrate W and vertically reversing the substrate W. While the reversal units REV1 and REV2 have similar functions, the reversal unit REV1 is employed for upwardly directing the rear surface of the substrate W and the reversal unit REV2 is employed for upwardly directing the surface of the substrate W in this embodiment.

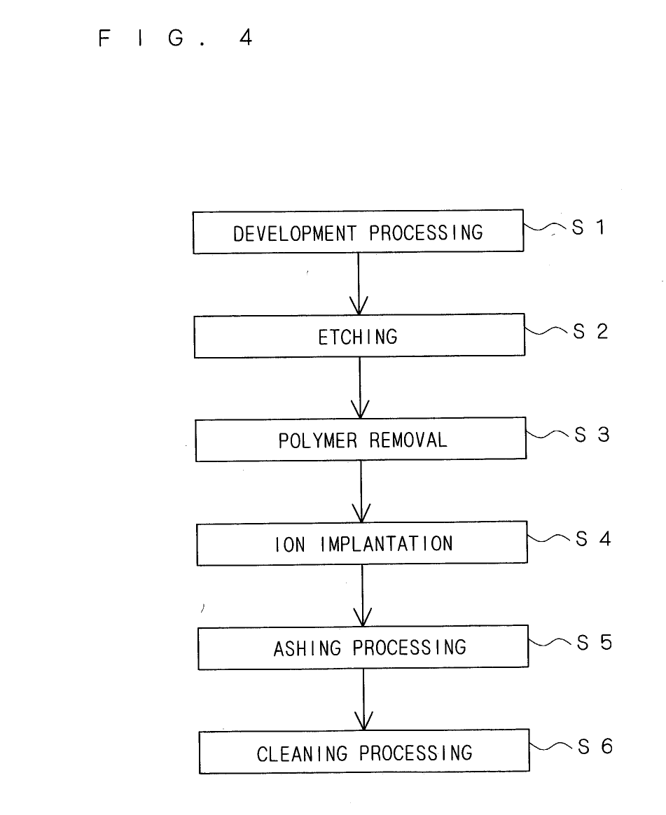

The contents of processing in the substrate processing apparatus 1 having the aforementioned structure are now described. First, partial steps of manufacturing a semiconductor device or the like are briefly described. FIG. 4 is a flow chart showing the partial steps of manufacturing a semiconductor device. FIG. 4 omits steps preceding exposure processing. A substrate manufacturing apparatus performs development processing of dissolving an exposed (or unexposed) part with a developer on the substrate W completely subjected to formation of an oxide film, resist coating and exposure processing (step S1). After the development processing, the substrate manufacturing apparatus dissolves the oxide film in a pattern shape by etching (step S2). Etching includes wet etching employing a chemical solution such as hydrofluoric acid and dry etching employing ions. While dry etching is particularly suitable for a fine circuit, resist is partially altered to a polymer by reactive ions to adhere to the substrate W in this case and hence the substrate manufacturing apparatus generally cleans the substrate W for removing the polymer (step S3).

Then, the substrate manufacturing apparatus performs ion implantation into a silicon part of the substrate W (step S4). After the ion implantation, no resist film is required and hence the substrate processing apparatus 1 performs resist separation. The substrate processing apparatus 1 performs ashing (step S5) for such resist separation. Since residual materials of the resist film adhere to the ashed substrate W as particles as already described, the substrate processing apparatus 1 cleans the ashed substrate (step S6). Thereafter the substrate manufacturing apparatus forms a protective film or the like and finishes the substrate W as a final product.

The substrate processing apparatus 1 according to this embodiment carries out the ashing processing (step S5) and the cleaning processing (step S6) among the aforementioned manufacturing steps. In other words, the substrate processing apparatus 1 continuously performs the cleaning processing and the immediately preceding ashing processing.

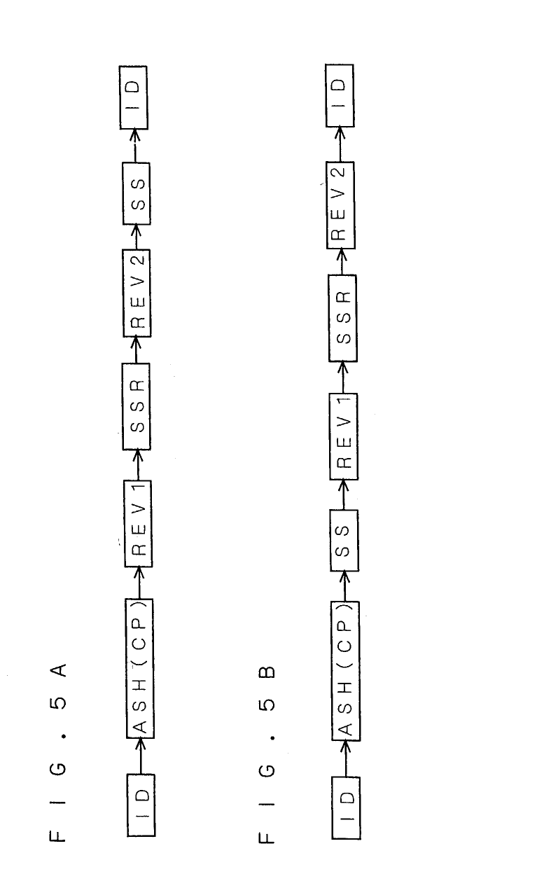

The procedure in the substrate processing apparatus 1 is now further described. FIGS. 5A and 5B are flow charts showing exemplary procedures of transporting the substrate W in the substrate processing apparatus 1. The substrate processing apparatus 1 performs ashing and immediately subsequent cleaning processing as hereinabove described, and a plurality of substrates W still having unnecessary resist films adhering thereto after ion implantation are introduced into the indexer ID of the substrate processing apparatus 1 as unprocessed substrates W stored in each carrier C.

Referring to FIG. 5A, the transfer robot TF of the indexer ID takes out a single unprocessed substrate W from any carrier C and transfers the same to the transport robot TR. The transport robot TR introduces the substrate W received from the indexer ID into the processing chamber 22 of the ashing part ASH of the ashing processing part 20. The ashing part ASH places the substrate W on the heating plate 21 in the single state and ashes the same. The temperature of the ashed substrate W is too high for the substrate processing apparatus 1 to clean the same as such, and hence the transport robot TR takes out the substrate W from the processing chamber 22 of the ashing part ASH and thereafter transfers the same to the processing chamber of the cooling part CP so that the cooling plate cools the same.

Thereafter the transport robot TR introduces the substrate W from the ashing processing part 20 into the reversal unit REV1 of the reversal part 50. The reversal unit REV1 vertically reverses the substrate W for upwardly directing the rear surface. The transport robot TR introduces the vertically reversed substrate W into the processing chamber 17 of the rear scrubber SSR of the cleaning processing part 10 in the single state. The rear scrubber SSR scrubs the rear surface of the substrate W. The rear scrubber SSR removes particles resulting from ashing, which may reach and adhere to the rear surface of the substrate W.

After the rear scrubber SSR cleans the rear surface of the substrate W, the transport robot TR introduces the substrate W from the cleaning processing part 10 into the reversal unit REV2 of the reversal part 50. The reversal unit REV2 vertically reverses the substrate W for upwardly directing the surface. The transport robot TR introduces the vertically reversed substrate W into the cleaning processing chamber of the surface scrubber SS of the cleaning processing part 10 in the single state. The surface scrubber SS scrubs the surface of the substrate W. The surface scrubber SS removes residual materials following ashing adhering to the surface of the substrate W as particles.

After the surface cleaning, the transport robot TR returns the substrate W from the cleaning processing part 10 to the indexer ID again. In other words, the transport robot TR transfers the processed substrate W to the transfer robot TF of the indexer ID, which in turn stores the substrate W in the carrier C. It follows that the carriers C each storing a plurality of processed substrates W are finally discharged from the indexer ID of the substrate processing apparatus 1.

FIG. 5B shows an alternative procedure for processing the substrate W in the substrate processing apparatus 1. Referring to FIG. 5B, the transfer robot TF of the indexer ID takes out a single unprocessed substrate W from any carrier C and transfers the same to the transport robot TR. The transport robot TR introduces the substrate W received from the indexer ID into the processing chamber 22 of the ashing part ASH of the ashing processing part 20. The ashing part ASH places the substrate W on the heating plate 21 and ashes the same. The transport robot TR takes out the ashed substrate W from the processing chamber 22 of the ashing part ASH and transfers the same into the processing chamber of the cooling part CP so that the cooling plate cools the same.

Thereafter the transport robot TR introduces the single substrate W from the ashing processing part 20 into the cleaning processing chamber of the surface scrubber SS of the cleaning processing part 10. The surface scrubber SS scrubs the surface of the substrate W. After the surface cleaning, the transport robot TR introduces the substrate W from the cleaning processing part 10 into the reversal unit REV1 of the reversal part 50. The reversal unit REV1 vertically reverses the substrate W for upwardly directing the rear surface. The transport robot TR introduces the vertically reversed substrate W into the cleaning processing chamber 17 of the rear scrubber SSR of the cleaning processing part 10 in the single state. The rear scrubber SSR scrubs the rear surface of the substrate W.

Thereafter the transport robot TR introduces the substrate W from the cleaning processing part 10 into the reversal unit REV2 of the reversal part 50. The reversal unit REV2 vertically reverses the substrate W for upwardly directing the surface thereof. The transport robot TR returns the vertically reversed substrate W to the indexer ID again. In other words, the transport robot TR transfers the processed substrate W to the transfer robot TF of the indexer ID, which in turn stores the substrate W in the carrier C.

In each of FIGS. 5A and 5B, the substrate processing apparatus 1 does not transport the carriers C from a plasma asher to a cleaning apparatus after storing a plurality of ashed substrates W in each carrier C dissimilarly to the prior art but the cleaning processing part 10 and the ashing processing part 20 are assembled into the substrate processing apparatus 1 so that the common transport robot TR transports the substrate W from the ashing processing part 20 performing ashing immediately before cleaning processing to the cleaning processing part 10 performing cleaning processing while holding the substrate W in the single state. Therefore, the substrate processing apparatus 1 can eliminate a dead time required for transporting the substrate W between apparatuses dissimilarly to the prior art.

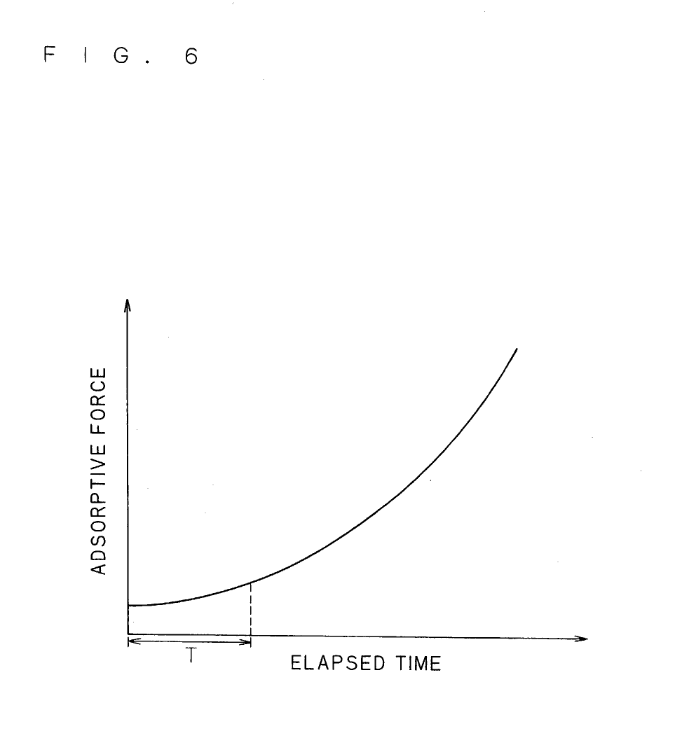

It follows that the substrate processing apparatus 1 cleans the substrate W in a relatively short time after ashing, and hence no particles resulting from ashing strongly adhere to the substrate W but the substrate processing apparatus 1 can improve cleaning performance. FIG. 6 illustrates the correlation between an elapsed time after ashing and adsorptive power of particles to the substrate W. As shown in FIG. 6, it follows that the particles strongly adhere to the substrate W as the elapsed time after ashing is increased. If the elapsed time after ashing is not more than “T”, the substrate processing apparatus 1 can remove the particles resulting from ashing from the substrate W not by scrubbing but by simply discharging functional water such as deionized water or ozone water to the substrate W.

In the substrate processing apparatus 1 according to this embodiment, the transport robot TR immediately transports the ashed substrate W to the cleaning processing part 10, whereby the time required from ashing to cleaning processing is short, no particles strongly adhere to the substrate W, the cleaning processing part 10 can readily remove the particles and the substrate processing apparatus 1 can improve cleaning performance.

The cleaning processing part 10 and the ashing processing part 20 are oppositely arranged flush with each other through the transport path 9, whereby the distance between these parts 10 and 20 is so reduced as to reduce the time required for the transport robot TR to transport the ashed substrate W to the cleaning processing part 10, so that the dead time can be more reliably eliminated and cleaning performance can be further improved.

The reversal part 50 vertically reverses the ashed substrate W for cleaning both surfaces thereof, whereby the substrate processing apparatus 1 can remove particles from the overall surfaces of the substrate W.

While the embodiment of the present invention has been described, the present invention is not restricted to the aforementioned embodiment. For example, while the cleaning processing part 10 and the ashing processing part 20 are assembled into the substrate processing apparatus 1 in the aforementioned embodiment, the substrate processing apparatus 1 performs cleaning processing a plurality of times in steps of manufacturing a semiconductor device or the like, and the cleaning processing part 10 and another processing part may be assembled into the substrate processing apparatus 1. For example, a film formation processing part forming an oxide film, an etching processing part etching the substrate W or the like may be assembled into the substrate processing apparatus 1 integrally with the cleaning processing part 10. When the cleaning processing part 10 cleaning the substrate W and a preprocessing part performing processing corresponding to a processing step immediately preceding the cleaning processing are integrally assembled into the substrate processing apparatus 1 so that the common transport robot TR transports the substrate W to these parts, the time required from the immediately preceding processing to the cleaning processing can be reduced for eliminating a dead time and cleaning performance can be improved by performing cleaning processing immediately after the aforementioned immediately preceding processing.

While the cleaning processing part 10 is formed by the spin scrubbers SS and SSR mechanically cleaning the substrate W with the cleaning brushes in the aforementioned embodiment, the present invention is not restricted to this but the cleaning processing part 10 may alternatively be formed by a unit cleaning the substrate W by spraying deionized water supplied with supersonics thereto, a unit cleaning the substrate W by spraying high-pressure deionized water thereto, a unit cleaning the substrate W by mixing a vapor phase into a liquid phase and spraying the mixture thereto, a unit cleaning the substrate W by supplying a chemical solution thereto, a unit cleaning the substrate W by supplying a removal solution to a polymer or the like.

While the ashing processing part 20 is formed by building the ashing part ASH and the cooling part CP therein in the aforementioned embodiment, the present invention is not restricted to this but the cooling part CP can be omitted if the temperature of the ashed substrate W is not much problematic.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus performing cleaning processing on a substrate subjected to prescribed processing, comprising:
a cleaning part performing said cleaning processing on said substrate in a cleaning processing chamber, said cleaning part including a surface cleaning part cleaning the surface of said substrate and a rear cleaning part cleaning the rear surface;
a preprocessing part performing said prescribed processing in its processing chamber as a processing step immediately preceding said cleaning processing;
a reversal part of reversing the upper surface of said substrate; and
a transport element transporting said substrate between said cleaning processing chamber of said cleaning part, said processing chamber of said preprocessing part and said reversal part, wherein
said cleaning part and said preprocessing part are integrally assembled into said substrate processing apparatus, and
said transport element takes out single said substrate completely subjected to said prescribed processing from said processing chamber of said preprocessing part, holds said substrate and transports said substrate to said cleaning processing chamber of said cleaning part in the single state.

2. The substrate processing apparatus according to claim 1, wherein
said cleaning part and said preprocessing part are substantially flush with each other.

3. The substrate processing apparatus according to claim 2, wherein
said cleaning part and said preprocessing part are arranged facing each other across a transport path where said transport element is arranged.

4. The substrate processing apparatus according to claim 3, further comprising an indexer part taking out an unprocessed substrate from a carrier while storing a processed substrate in said carrier, wherein
said transport element transports said unprocessed substrate received from said indexer part successively from said preprocessing part to said cleaning part and transfers said processed substrate received from said cleaning part to said indexer part.

5. The substrate processing apparatus according to claim 4, wherein
said prescribed processing is ashing processing, and said preprocessing part is an ashing processing part.

6. The substrate processing apparatus according to claim 5, wherein
said transport element transports said substrate received from said indexer part from said ashing processing part to said reversal part, transports said substrate reversed in said reversal part to said reversal part again through said rear cleaning part, and transfers said substrate reversed in said reversal part again to said indexer part through said surface cleaning part.

7. The substrate processing apparatus according to claim 5, wherein
said transport element transports said substrate received from said indexer part from said ashing processing part to said reversal part through said surface cleaning part, transports said substrate reversed in said reversal part to said reversal part again through said rear cleaning part and transfers said substrate reversed in said reversal part again to said indexer part.

8. The substrate processing apparatus according to claim 5, wherein
said cleaning part comprises a rotation mechanism rotating said substrate in a substantially horizontal plane and a discharge mechanism discharging a detergent to said substrate in its cleaning processing chamber.

9. The substrate processing apparatus according to claim 8, wherein
said ashing processing part comprises a cooling part cooling ashed said substrate.

10. A substrate processing apparatus performing cleaning processing on a substrate subjected to prescribed processing, comprising:
a cleaning part performing said cleaning processing on said substrate in a cleaning processing chamber;
a preprocessing part performing said prescribed processing in its processing chamber as a processing step immediately preceding said cleaning processing; and
a transport element introducing/discharging said substrate into/from both of said cleaning processing chamber of said cleaning part and said processing chamber of said preprocessing part, wherein
said cleaning part and said preprocessing part are integrally assembled into said substrate processing apparatus and arranged facing each other across a transport path where said transport element is arranged, and
said transport element takes out single said substrate completely subjected to said prescribed processing from said processing chamber of said preprocessing part, holds said substrate and transports said substrate to said cleaning processing chamber of said cleaning part in the single state.

11. The substrate processing apparatus according to claim 10, wherein
said cleaning part and said preprocessing part are substantially flush with each other.

12. The substrate processing apparatus according to claim 11, further comprising an indexer part taking out an unprocessed substrate from a carrier while storing a processed substrate in said carrier, wherein
said transport element transports said unprocessed substrate received from said indexer part successively from said preprocessing part to said cleaning part and transfers said processed substrate received from said cleaning part to said indexer part.

13. The substrate processing apparatus according to claim 12, further comprising a reversal part reversing the upper surface of said substrate, wherein
said cleaning part includes a surface cleaning part cleaning the surface of said substrate and a rear cleaning part cleaning the rear surface.

14. The substrate processing apparatus according to claim 13, wherein
said prescribed processing is ashing processing, and said preprocessing part is an ashing processing part.

15. The substrate processing apparatus according to claim 14, wherein
said cleaning part comprises a rotation mechanism rotating said substrate in a substantially horizontal plane and a discharge mechanism discharging a detergent to said substrate in its cleaning processing chamber.

16. The substrate processing apparatus according to claim 15, wherein
said ashing processing part comprises a cooling part cooling ashed said substrate.
